(19) United States
(12) Patent Application Publication
(10) Pub. No.: US 2024/0160280 A1
(43) Pub. Date: May 16, 2024

(54) METHOD FOR CONTROLLING DATA GLASSES, DEVICE AND DATA GLASSES

(71) Applicant: Robert Bosch GmbH, Stuttgart (DE)

(72) Inventors: Lukas Grinewitschus, Reutlingen (DE); Dominik Neeser, Reutlingen (DE); Rudolf Bichler, Eningen (DE)

(21) Appl. No.: 18/488,119

(22) Filed: Oct. 17, 2023

(30) Foreign Application Priority Data
Nov. 15, 2022 (DE) 10 2022 212 095.7

(51) Int. Cl. G06F 3/01; G02B 27/01

(52) U.S. Cl. CPC G06F 3/012; G02B 27/017; G02B 2027/0178

(57) ABSTRACT

A method for controlling data glasses. The method includes a step of reading a sensor signal of a sensor unit arranged on the data glasses, wherein the sensor signal represents a change of position of the data glasses in relation to a defined reference point and additionally or alternatively represents a movement of the data glasses. The method also includes a step of applying a function rule for controlling a function of the data glasses by using the sensor signal.

### CROSS REFERENCE

The present application claims the benefit under 35 U.S.C. § 119 of German Patent Application No. DE 10 2022 212 095.7 filed on Nov. 15, 2022, which is expressly incorporated herein by reference in its entirety.

### BACKGROUND INFORMATION

The present invention relates to a method for controlling data glasses, a device, and data glasses. The present invention also relates to a computer program.

Data glasses or so-called smart glasses can comprise different components, such as a screen, a computing unit, sensors, a display/projector, cameras, loudspeakers, microphones or further items. Current glasses can, for example, offer the possibility of playing music or controlling a smartphone connected to the glasses by inputs on the glasses. Furthermore, virtual reality glasses or augmented reality glasses exist in which a position and orientation can be determined in order to adjust a representation in the field of view of a user correspondingly.

### SUMMARY

The present invention provides a method for controlling data glasses, as well as a device that uses this method, data glasses and finally a corresponding computer program. Advantageous example embodiments, developments, and improvements of the device are disclosed herein.

With the method presented here, functions of the data glasses can advantageously be controlled, with which functions an energy consumption of the glasses can be reduced and in this way a user can be supported in a particularly advantageous manner during everyday activities.

According to the present invention, a method for controlling a pair of data glasses is presented. According to an example embodiment of the present invention, the method comprises a step of reading a sensor signal of a sensor unit arranged on the data glasses, wherein the sensor signal represents a change of position of the data glasses in relation to a defined reference point and additionally or alternatively a movement of the data glasses. In addition, the method comprises a step of applying a function rule for controlling a function of the data glasses by using the sensor signal.

The data glasses, which can also be referred to as glasses for short, can be for example so-called smart glasses. The data glasses can be designed, for example, to display different items of information on a display, for example in one or both lenses. Additionally or alternatively, the data glasses can be designed as so-called virtual reality glasses or augmented reality glasses and, for example, interactions with other devices networked with the data glasses, such as a smartphone, can be possible. The data glasses can have at least one or even a plurality of sensor units or different types of sensors in order to determine the position and the orientation of the glasses in space. The sensor types can be, for example, acceleration sensors, yaw-rate sensors, and magnetic field sensors. The sensor types can be installed either in separate sensors or in one sensor, such as in an inertial measurement unit (IMU). The sensor types record, for example, signals in one, two or three different dimensions. Provided a user wears the glasses on the nose, this can be evaluated as a reference point or starting point, for example. If the glasses are taken off or pushed up on the head, the position and orientation of the glasses can change in relation to the reference point. The change of position can be detected via different sensors or combinations of the sensors. For example, acceleration sensors and yaw-rate sensors can be used to detect the movement of the glasses. The sensors can, for example, be installed in or attached to the frame of the glasses, for example on one or both sides of the glasses or on the bridge. Furthermore, proximity sensors or pressure sensors in the temples, the bridges, or the nose pads can be used to detect whether the glasses have been taken off. The sensors can generate analog signals which can be converted into digital signals. According to an example embodiment of the present invention, by using these sensor signals, in the method presented here, a change of position or a movement of the data glasses can be detected. For example, such a movement can be a movement of the head of a person wearing the data glasses. By means of the sensor signal, it can thus be determined, for example, whether an inclination or rotation of the head and thus also of the data glasses is being carried out and additionally or alternatively whether the person is moving through space, for example. Additionally or alternatively, a change of position of the data glasses in relation to the person can be detected. For example, the base of the nose of a user of the data glasses can be set as reference point; i.e., provided the user is wearing the glasses on the nose, this can, for example, be evaluated as the starting point. If the glasses are taken off or pushed up on the head, the position and orientation of the glasses in relation to the starting point will change. By using the sensor signal or in response to a detected movement or change of position of the data glasses, a function rule is applied in the method presented here. As a result, functions of the data glasses matched to a specific movement and additionally or alternatively to the position of the data glasses can advantageously be controlled, for example in order to put the glasses into an energy-saving mode or to start and control a specific application. In this case, a position and orientation of the glasses can advantageously be determined without the aid of cameras.

According to one example embodiment of the present invention, the function rule can be applied in the application step in order to control a measurement function for measuring an object. Additionally or alternatively, the function rule can be applied in order to control a spirit-level function for aligning objects and additionally or alternatively to control an operating state function for controlling an operating state of the data glasses. For example, the data glasses can comprise various applications which can be realized using the information about the position and orientation of the glasses in relation to a starting point. An application, for example, can make it possible to reduce the energy consumption of the glasses. This can be realized by detecting whether the user has taken the glasses off or has pushed up them on the head, for example. In both cases, the glasses could switch into the standby mode in order to advantageously save energy. Furthermore, the glasses can be used, for example, as a spirit level or as a height or distance measurement device. The use of the glasses as a spirit level advantageously allows the user to hang and align a picture on the wall without needing to hold a spirit level in the hand. Instead, the spirit level can be overlaid, for example, in the field of view of the user. Furthermore, with his glasses the user can measure distances and heights without using a further device. Distances and heights can, for example, be determined by triangulation using the information about the position and orientation of the glasses and advantageously enable the user to measure the surroundings without the need for additional devices.

According to a further embodiment of the present invention, in the application step, by using the sensor signal a directional angle of the data glasses in relation to the object to be measured can be determined, wherein by using the directional angle the object can be measured. The glasses can be used, for example, for measuring objects. For example, the height of objects, such as a house, can be measured with the aid of the glasses. Alternatively, this method can also be used to determine how many meters certain objects are above or below the user. For measurement of the height, the user can, for example, focus on the point, the height difference of which he wants to know, for example a gable of the house. The directional angle can result from the focusing. The accuracy of determination of the angle can be increased, for example, in that, for example, a reticle or a dot is overlaid in the field of vision of the user, with the aid of which the gable of the house can be focused on, for example. If the distance and the height of the glasses above the ground are known, the height of the house can now be determined. This presupposes that the object and the user are located on the same level. With greater heights, the height of the glasses above the ground can be approximatively disregarded. This type of measurement offers the advantage that no further devices are required and objects can thereby be measured quickly and efficiently.

In addition, according to an example embodiment of the present invention, the method can comprise a step of re-reading the sensor signal. In this case, in the application step, by using the re-read sensor signal a further directional angle of the data glasses in relation to the object to be measured and/or a distance which the data glasses have covered can be determined, wherein by using the directional angle and the further directional angle and/or the distance the object can be measured. However, the sensor signal need not be read only at the target point in order to acquire the directional angle. It can instead be a regular reading of the sensor signal. The sensor signal is read, for example, in order to obtain the directional angle at the starting point; the sensor signal is then read in order to measure the distance covered and also to detect that the glasses have moved slightly again and a second directional angle can be acquired. For example, in this variant of measurement, a user can first focus on a gable of the house of which the height is to be determined, for example. A first position of the user or the starting point of the glasses and the directional angle can be captured. In the next step, the user can move in the direction of the object of which the height is to be determined. After the user has covered a certain distance and has reached a second position, the gable of the house can be focused on again. The further directional angle and the distance or its associated directional vector between the first and the second point can be captured. The height of the house can now be determined from the acquired variables. This measurement variant offers the advantage that no additional devices nor any distance measuring devices are required in addition to the data glasses.

According to a further embodiment of the present invention, in the application step, by using the sensor signal a display for displaying a spirit-level symbol can be controlled. In this case, the spirit-level symbol can be displayed horizontally in relation to a width of the data glasses and additionally or alternatively horizontally in relation to a gravitational field of the earth. For example, by means of the orientation of the glasses, a spirit-level app can be realized which overlays for the user a horizontal line in the field of view of the glasses when the user holds his head, and thus the glasses, straight. The horizontal line can be overlaid at the height of the pupil. Alternatively, the line which can be displayed in the field of view of the user can always be horizontal in relation to the surroundings. If the user tilts his head, the line can be rotated accordingly. Additionally or alternatively to the horizontal line in the field of view of the user, a vertical line or a cross can also be displayed. The vertical line or the cross can be realized analogously to the horizontal line in the two variants described above. The possibility of using the glasses as a spirit level advantageously enables the user to align an object, for example a picture, without using a separate spirit level. In this way, holding a regular spirit level in the hand can be avoided. In addition to a regular spirit level, it is also possible to use a laser-assisted spirit level. However, the laser-supported spirit level should either be set up on a tripod or be fastened to the wall. This additional working step is unnecessary if glasses with a built-in spirit level are used.

In addition, according to an example embodiment of the present invention, in the application step, a color marking of the spirit-level symbol can be changed if in the reading step the sensor signal is read which represents a movement of the data glasses into a non-horizontal orientation of the data glasses in relation to the gravitational field. For example, the spirit-level symbol can be drawn as a horizontal line at the height of the pupil of the user. Provided the user holds his head straight, the horizontal line can, for example, shine green. As soon as the head is tilted, the line can change color and, for example, shine red. So that the user knows in the event of a red line in which direction said user should tilt his head, additional information can also be displayed in the glasses. Advantageously, a use of the data glasses for aligning objects can be facilitated by a color marking of the spirit-level symbol.

According to a further embodiment of the present invention, in the application step an active operating state can be controlled as an operating state function if, in the reading step, the sensor signal represents a change of position of the data glasses into an active position at the defined reference point. In this case, a passive operating state can be controlled if, in the reading step, the sensor signal represents a change of position of the data glasses into a passive position from the reference point to a different point arranged at a distance from the reference point. An active position can be a position of the glasses in the worn state, for example if the nose of the user is recognized as a reference point. In this position, the data glasses can be put into an active operating state in which all functions are available. If, on the other hand, the glasses have been taken off or pushed up on the head, that is to say moved away from the reference point, a passive operating state can be made possible in which, for example, functions are restricted in order to advantageously save energy. In other words, by means of the sensor units it is possible to detect whether a user has put on or taken off the glasses, is wearing them correctly, or has pushed the glasses up on his head. This detection can also be referred to below as state detection of the glasses. If the user takes off the glasses, they can switch, for example, into a standby mode in order to save energy. The same can apply if the glasses have been pushed up on the head. The different scenarios can be distinguished by evaluating the sensor signals. It is furthermore possible to use the state detection of the glasses for further operations, such as putting the glasses into a sleep mode in which, for example, the display, the camera, and the audio playback of the glasses can be switched off. In order to advantageously reduce the waiting time until the glasses are ready for use after having been switched on, the glasses can already be switched on or woken from the standby mode or sleep mode once the putting-on process has started. The glasses can thus advantageously be used immediately after the user has put them on.

In addition, according to an example embodiment of the present invention, the method can comprise a step of calibrating the data glasses if a passive operating state is being controlled in the application step. If, for example, it is detected that the glasses have been taken off, for example, and are in a location at which the glasses are not moving, a calibration or a recalibration of, for example, the display/projector can be carried out. This offers the advantage that all functions of the data glasses can be optimally executed as soon as the data glasses have been transferred back into an active state.

This method can be implemented, for example, in software or hardware or in a mixed form of software and hardware, for example in a control device.

The approach presented here according to the present invention further provides a device which is designed to carry out, actuate or implement the steps of a variant of a method presented here in corresponding apparatuses. The object of the present invention can also be achieved quickly and efficiently by this design variant of the present invention in the form of a device.

According to an example embodiment of the present invention, for this purpose, the device can have at least one computing unit for processing signals or data, at least one memory unit for storing signals or data, at least one interface to a sensor or an actuator for reading in sensor signals from the sensor or for outputting data signals or control signals to the actuator, and/or at least one communication interface for reading in or outputting data embedded in a communication protocol. The computing unit can, for example, be a signal processor, a microcontroller or the like, and the memory unit can be a flash memory or a magnetic memory unit. The communication interface can be designed to read in or output data in a wireless and/or wired manner, a communication interface, which can read in or output line-bound data, being able to read in these data, for example electrically or optically, from a corresponding data transmission line, or being able to output these data into a corresponding data transmission line.

In the present case, a device can be understood to be an electrical device that processes sensor signals and, on the basis of these signals, outputs control and/or data signals. The device can have an interface that can be designed as hardware and/or software. In a hardware embodiment, the interfaces can, for example, be part of a so-called system ASIC, which contains a wide variety of functions of the device. However, it is also possible for the interfaces to be separate integrated circuits or at least partially consist of discrete components. In a software embodiment, the interfaces can be software modules that are present, for example, on a microcontroller in addition to other software modules.

In addition, a pair of data glasses is presented having a variant of the above-described device and having at least one sensor unit for detecting a change of position of the data glasses in relation to a defined reference point and additionally or alternatively a movement of the data glasses. All advantages of the method presented above can be optimally implemented with this combination.

A computer program product or a computer program with program code that can be stored on a machine-readable carrier or storage medium, such as a semiconductor memory, a hard disk memory, or an optical memory, and that is used for carrying out, implementing, and/or actuating the steps of the method according to one of the embodiments of the present invention described above is advantageous as well, in particular when the program product or program is executed on a computer or a device.

Exemplary embodiments of the present invention are illustrated in the figures and explained in more detail in the following description.

### BRIEF DESCRIPTION OF THE DRAWINGS

FIG. 1 shows a schematic representation of data glasses according to one exemplary embodiment of the present invention.

FIG. 2A shows a flow chart of a method for controlling data glasses according to one exemplary embodiment of the present invention.

FIG. 2B shows a flow chart of a method for controlling data glasses according to one exemplary embodiment of the present invention.

FIG. 3 shows a schematic representation of a measurement function controllable by means of data glasses according to one exemplary embodiment of the present invention.

FIG. 4 shows a diagram of a sensor signal according to one exemplary embodiment of the present invention.

FIG. 5 shows a diagram of a sensor signal according to one exemplary embodiment of the present invention.

FIG. 6 shows a schematic representation of a measurement function controllable using glasses according to one exemplary embodiment of the present invention.

FIG. 7A shows a schematic representation of a spirit-level function controllable using data glasses according to one exemplary embodiment of the present invention.

FIG. 7B shows a schematic representation of a spirit-level function controllable by means of data glasses according to one exemplary embodiment of the present invention.

FIG. 7C shows a schematic representation of a spirit-level function controllable by means of data glasses according to one exemplary embodiment of the present invention.

FIG. 7D shows a schematic representation of a spirit-level function controllable by means of data glasses according to one exemplary embodiment of the present invention.

FIG. 8A shows a schematic representation of an operating state function controllable by means of data glasses according to one exemplary embodiment of the present invention.

FIG. 8B shows a schematic representation of an operating state function controllable by means of data glasses according to one exemplary embodiment of the present invention.

FIG. 8C shows a schematic representation of an operating state function controllable by means of data glasses according to one exemplary embodiment of the present invention.

FIG. 9 shows a diagram 900 of a sensor signal 115 according to one exemplary embodiment of the present invention.

### DETAILED DESCRIPTION OF EXAMPLE EMBODIMENTS

In the following description of advantageous exemplary embodiments of the present invention, the same or similar reference signs are used for the elements shown in the various figures and acting similarly, as a result of which a repeated description of these elements is omitted.

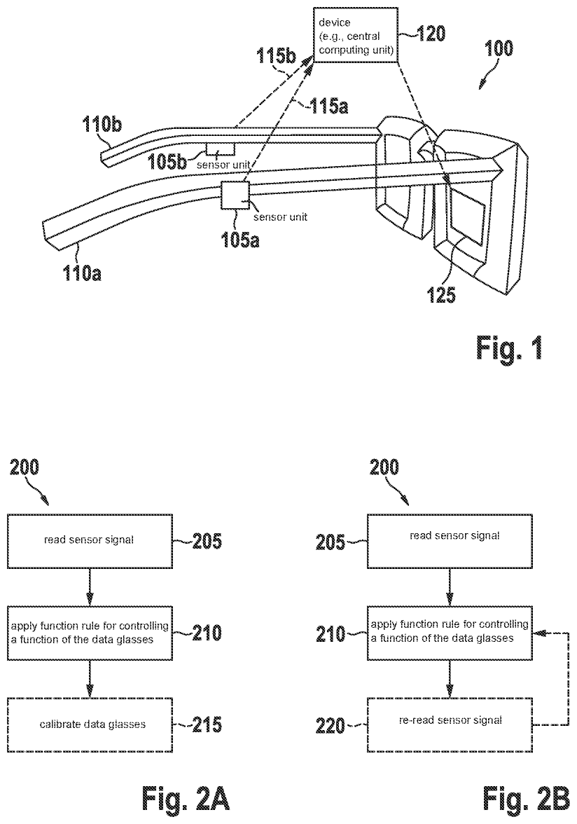

FIG. 1 shows a schematic representation of a pair of data glasses 100 according to one exemplary embodiment. In this exemplary embodiment, the data glasses 100 comprise two sensor units 105a, 105b, which are arranged only by way of example on the temples 110a, 110b of the data glasses 100. In one exemplary embodiment, the sensor units 105a, 105b, which can also be simply referred to as sensors, are designed as acceleration sensors for detecting a movement or a change of position of the data glasses 100. By way of example, it can be detected by means of the sensors whether the glasses are being worn or have been taken off by a user. Furthermore, it can be detected whether the glasses are being worn on the nose or have been pushed up on the head. In order to determine the position and the orientation of the glasses in space, the glasses in other exemplary embodiments can additionally or alternatively have various other sensors and sensor types. Not only some but also all sensor types can be used. The sensor types can, for example, be acceleration sensors, yaw-rate sensors, pressure sensors, and magnetic field sensors. The sensors can be installed in or attached to the frame of the glasses. In the exemplary embodiment shown here, the sensor units 105a, 105b are mounted only by way of example on both sides of the glasses. In other exemplary embodiments, it is also possible that the sensors are mounted only on one of the two sides. Optionally, the sensors can also be installed in or attached to the bridge.

The sensor units 105a, 105b are designed to provide analog signals which are converted into digital signals, i.e. into sensor signals 115a, 115b. In this case, the sensor signals 105a, 105b represent a change of position of the data glasses in relation to a defined reference point and also, by way of example, a movement of the data glasses. The digital sensor signals 115a, 115b can be read by a device 120. In one exemplary embodiment, the device 120 is a central computing unit which is installed together with the sensor. Alternatively, the computing unit can be arranged in a sensor housing or on an external server, for example as a so-called cloud.

The device 120 is designed to read and evaluate the sensor signals 115a, 115b and, using the signals, apply a function rule for controlling a function of the data glasses. In one exemplary embodiment, the device is designed by way of example to control a display 125 for displaying a spirit-level symbol in order to facilitate for the user a horizontal alignment of an object. In other exemplary embodiments, by using at least one sensor signal the function rule can be applied to control, by way of example, an operating state of the data glasses or to enable a measurement of an object. The data glasses 100 shown here accordingly enable the use of different types of sensors to determine the position and orientation of the glasses in relation to a starting point for the realization of various applications.

FIG. 2A shows a flowchart of a method 200 for controlling data glasses according to one exemplary embodiment. By means of the method 200 shown here, functions of data glasses, as has been described in the preceding figure, can be controlled by way of example.

The method 200 comprises a step 205 of reading a sensor signal of a sensor unit arranged on the data glasses, wherein the sensor signal represents a change of position of the data glasses in relation to a defined reference point and additionally or alternatively represents a movement of the data glasses.

In addition, the method 200 comprises a step 210 of applying a function rule for controlling a function of the data glasses by using the sensor signal.

In one exemplary embodiment, the function rule is applied in the application step in order to control an operating state function for controlling an operating state of the data glasses. In this case, an active operating state is controlled merely by way of example as an operating state function if, in the reading step, the sensor signal represents a change of position of the data glasses into an active position at the defined reference point. In contrast, the data glasses are put into a passive operating state by way of example if, in the reading step 205, the sensor signal represents a change of position of the data glasses into a passive position from the reference point to a different point arranged at a distance from the reference point. In other words, in such an application, sensors are used to detect whether the glasses are being put on or taken off. Furthermore, it is detected whether the glasses are being worn on the nose or have been pushed up on the head. If the glasses are taken off or pushed up on the head, the glasses will change, for example, into the standby mode in order to save energy.

In one exemplary embodiment, an optional step 215 of calibrating the data glasses is carried out when a passive operating state is being controlled in the application step 210. This is only enabled by way of example when the glasses have been taken off or placed at a location remote from a user.

FIG. 2B shows a flowchart of a method 200 for controlling data glasses according to one exemplary embodiment. The method 200 shown here corresponds to or is similar to the method described in the preceding figure, with the difference that it has additional or alternative steps.

In this exemplary embodiment, the function rule is applied in the application step 210 in order to control a measurement function for measuring an object.

If, in one exemplary embodiment, the function rule is applied in the application step in order to control a measurement function, only by way of example will a directional angle of the data glasses in relation to the object to be measured then be determined using the sensor signal. For this purpose, in one exemplary embodiment, the sensor signal is read again in a re-reading step 220, wherein in the application step 210 a further directional angle of the data glasses in relation to the object to be measured is determined using the re-read sensor signal. Using the directional angle and the further directional angle, in one exemplary embodiment the object is measured. Furthermore, the sensor signal can also be read between the positions in order to determine the distance covered. With the knowledge of the distance covered, the object can be measured very precisely.

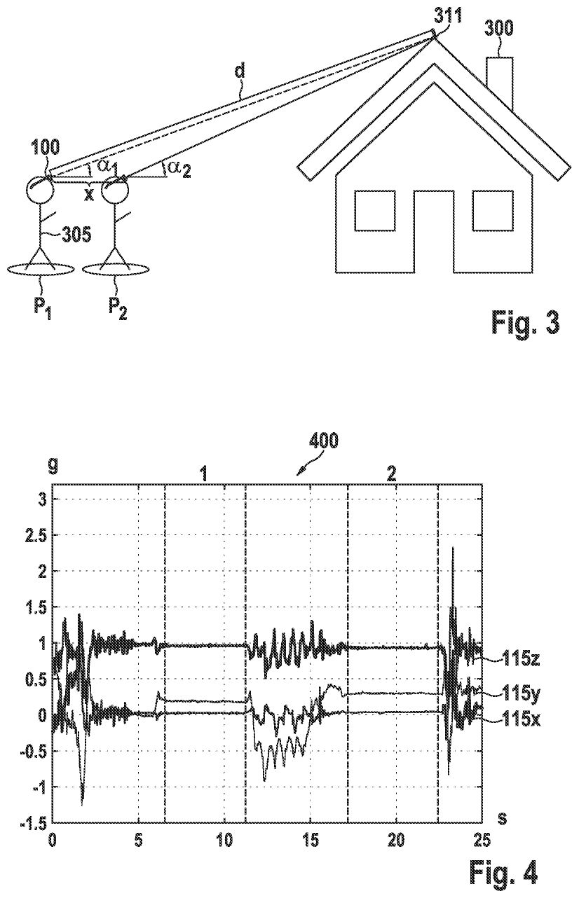

FIG. 3 shows a schematic representation of a measurement function controllable by means of data glasses 100 according to one exemplary embodiment. In this application example, the data glasses 100 can be used for measuring objects. The measurement of the object 300 shown here can, for example, be controllable in an application step as described in the preceding FIG. 2.

The illustration shown here shows by way of example how the height of an object 300, which by way of example is a house, can be measured with the aid of the glasses. Alternatively, this method can also be used to determine how many meters certain objects are located above or below the user 305. By way of example, two different approaches can be used for measuring the height.

In the first variant, the user 305 focuses on the point of which the height difference he would like to know. In the representation shown here, the user 305 in a first position P₁ focuses only by way of example on the gable 311 of the house. The directional angle α₁ results from the focusing. The accuracy of determination of the angle α₁ can be increased, for example, in that a reticle or a dot is overlaid in the field of vision of the user 305, with the aid of which the gable 311 of the house must be focused on, for example. The height of the house can now be determined via two different variants. If the distance d and the height of the glasses above the ground is known, the height of the house can be determined. This naturally presupposes that the house and the user 305 are located on the same level. With greater heights, the height of the glasses above the ground can be approximatively disregarded.

To determine the distance d, a distance measuring device is required. This may possibly be impractical, which is why a further variant for determining the height is presented here. In the second variant, the user 305 first focuses on the gable 311 of the house. The first position P₁ of the user or the starting point of the data glasses 100, and also the directional angle α₁, are captured. In the next step, the user 305 moves in the direction of the object 300 of which the height is to be determined, i.e., for example, in the direction of the house. After the user 305 has covered a distance x and reached a second position P₂, the user 305 focuses once more on the gable 311 of the house. The further directional angle α₂ resulting from the re-focusing and also the distance x or its associated directional vector between the first and the second point are captured. The height of the house can now be determined from the acquired variables.

FIG. 4 shows a diagram 400 of a sensor signal 115 according to one exemplary embodiment. The sensor signal 115 shown here is merely an example of an acceleration g, plotted against time s, of a signal of an acceleration sensor of a pair of data glasses, as described in the preceding FIGS. 1 and 3, while a user of the data glasses is determining the height of an object. In this case, the sensor signal 115 is shown three times by way of example in order to present the signal not only as a sensor signal 115x along an x axis of the diagram 400, but also as a sensor signal 115y along a y axis and also as a sensor signal 115z along a z axis of the diagram 400.

In the diagram 400 shown here, two regions with numbers 1 and 2 are highlighted. The two regions correspond to the two positions of the stick figure in the preceding FIG. 3, wherein the region 1 corresponds to a time interval of approximately 6.5 to 11 seconds, and the region 2 corresponds to a time interval of approximately 17 to 23 seconds. In the region between the highlighted regions, the user has walked towards the object, which results in greater deflections in the representation of the sensor signal 115. In the regions 1 and 2, on the other hand, the object to be measured is targeted and the signal remains relatively constant in comparison with the movements before and after the highlighted regions. As can be seen in this illustration, the values of the acceleration signal 115 differ in the ranges 1 and 2. For example, the sensor signal 115y thus has an exemplary acceleration of 0.2 along the y axis in the range 1 and an exemplary acceleration of 0.3 in the range 2. Different angles can thus be determined from the values of the acceleration signal.

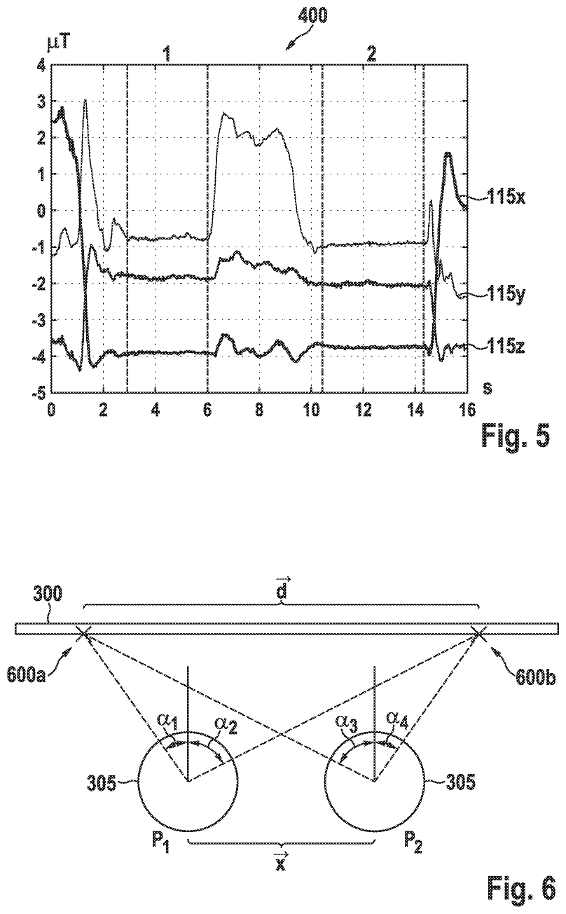

FIG. 5 shows a diagram 400 of a sensor signal 115 according to one exemplary embodiment. The sensor signal 115 shown here is merely an example of a magnetic flux density μT, plotted against time s, of a signal of a magnetic field sensor of a pair of data glasses, as described in the preceding FIGS. 1 and 3, while a user of the data glasses is determining the height of an object. In this case, the sensor signal 115 is shown three times by way of example in order to present the signal not only as a sensor signal 115x along an x axis of the diagram 500, but also as a sensor signal 115y along a y axis and also as a sensor signal 115z along a z axis of the diagram 500.

In addition to acceleration signals, as described in the preceding FIG. 4, signals of a magnetic field sensor can also be used. In the representation shown here, the signals of a magnetic field sensor are plotted against time, while the user is measuring the height of an object. In this case, two phases which are numbered with the numbers 1 and 2 are highlighted, wherein the phase 1 corresponds to a time interval of approximately 3 to 6 seconds and the phase 2 corresponds to a time interval of approximately 10.5 to 14.5 seconds. The two phases correspond to the two positions of the stick figure in the preceding FIG. 3. In the two phases, the signals of the magnetic field sensor are captured, while the user is focusing on the object of which the height is to be determined. In order to improve the measurement, the signals can, for example, be averaged over the duration of the phases. The orientation of the head can be deduced from the determined values of the magnetic flux density, and the directional angle can thus be determined.

FIG. 6 shows a schematic representation of a measurement function that can be controlled by means of data glasses according to one exemplary embodiment. The measurement of the object 300 shown here can, for example, be controllable in an application step as described in the preceding FIG. 2. In this exemplary embodiment, the object 300 is a wall.

In addition to the height of an object 300, a horizontal distance on a wall, for example between two drilled holes 600a, 600b, can also be determined. In the illustration shown here the drilled holes 600a, 600b are marked in each case by means of a cross. The method shown in this figure can be used to measure any distances that can also have other directions in addition to a horizontal one. In the illustration shown here, a plan view can be seen which shows two positions P₁, P₂ of a user 305. The user 305 is shown as a circle. The user 305 is firstly at the first position P₁ and focuses once on the left-hand cross, i.e. the first drilled hole 600a, and on the right-hand cross, i.e. the second drilled hole 600b. The user 305 then moves to the second position P₂. At the second position P₂ the user 305 focuses again on the left-hand and right-hand crosses. With the aid of the angles α₁, α₂, α₃, α₄ and also with the vector \vec{ }, the vector \vec{ } or the horizontal distance between the drilled holes 600a, 600b can be determined.

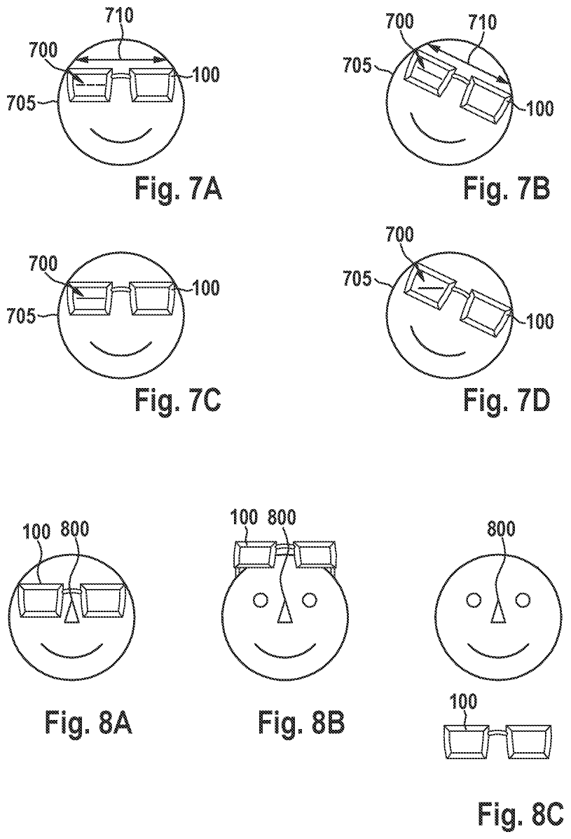

FIGS. 7A, 7B, 7C, and 7D in each case show a schematic representation of a spirit-level function controllable by means of data glasses 100 according to one exemplary embodiment. In this exemplary embodiment, the data glasses 100 can be used as a spirit level in that, by using the sensor signal, only by way of example a display for displaying a spirit-level symbol 700 is controlled. For the use of the spirit level, the inclination of the head 705 can be detected by way of example with the aid of acceleration sensors, yaw-rate sensors or magnetic field sensors. The spirit level can be realized, for example, in two different variants.

In the first variant, which is shown in this representation in FIGS. 7A and 7B, the spirit-level symbol 700 can be displayed horizontally in relation to a width 710 of the data glasses. In other words, a horizontal line in relation to the glasses is displayed to the user in the field of view of the glasses. The horizontal line is drawn at the height of the pupil. Provided the user holds his head 705 straight, the horizontal line in this exemplary embodiment will shine green. As soon as the head 705 is tilted, the line changes its color and, for example, shines red. So that the user knows in the event of a red line in which direction said user has to tilt his head 705, in one exemplary embodiment additional information can also be displayed in the glasses.

In the second variant, which is shown in this representation in FIGS. 7A and 7B, the spirit-level symbol 700, which can be displayed by way of example as a line in the field of view of the user, is always horizontal in relation to the surroundings, or horizontal in relation to a gravitational field of the earth. If the user tilts his head 705, the line is rotated accordingly.

As an alternative to the horizontal line in the field of view of the user, a vertical line or a cross can also be displayed. The vertical line or the cross can be realized analogously to the horizontal line in the two variants described above. The possibility of using the glasses as a spirit level enables the user to align a picture, for example, without having to use a separate spirit level. As a result, the user avoids having to hold a regular spirit level in his hand. In addition to a regular spirit level, there is also the possibility of using a laser-assisted spirit level. However, the laser-supported spirit level must either be set up on a tripod or be fastened to the wall. This additional working step is unnecessary if glasses with a built-in spirit level are used.

FIGS. 8A, 8B and 8C in each case show a schematic representation of an operating state function controllable by means of data glasses 100 according to one exemplary embodiment. Here, an active operating state of the data glasses 100 is activated in FIG. 8A and a passive operating state is activated in FIGS. 8B and 8C. By way of example, the active operating state can be implemented by positioning the data glasses 100 at an active position at the defined reference point 800. The reference point is, for example, the nose of the user. A passive operating state is, for example, by a change of position of the data glasses 100 into a passive position from the reference point 800 to a different point arranged at a distance. By way of example, in FIG. 8B the data glasses 100 have accordingly been pushed over the nose and up onto the head and in FIG. 8C the data glasses have been taken off entirely.

In other words, the exemplary embodiment shown here relates to the detection as to whether a user has put on or taken off the glasses, is wearing them correctly, or has put the glasses on his head. This detection is referred to below as a state detection of the glasses. If the user takes off the glasses, they will switch, by way of example, into a standby mode in order to save energy. The same applies if the glasses are pushed up on the head. The different scenarios can be distinguished by evaluating the sensor signals. The representation shown here includes different scenarios in which the glasses are either switched on (active) or in the standby mode (passive).

It is furthermore possible to use the state detection of the glasses for further processes, such as switching the glasses into a sleep mode in which the display, the camera and the audio playback of the glasses are switched off. If it is detected that the glasses have been taken off, for example, and are at a location at which the glasses are not moving, in one exemplary embodiment a recalibration of the display/projector can be carried out. In order to reduce the waiting time until the glasses are ready for use after being switched on, the glasses can already be switched on or be woken from the standby mode or sleep mode when the putting-on process is started. The glasses can thus be used immediately after the user puts them on.

If the user wears the glasses on the nose, this is regarded as the starting point, for example. If the glasses are taken off or pushed up on the head, the position and orientation of the glasses in relation to the starting point will change. The change of position can be detected via different sensors or combinations of the sensors. For example, acceleration sensors and yaw-rate sensors can be used to detect the movement of the glasses. Furthermore, proximity sensors or pressure sensors can be used in the temples, the bridges, and/or the nose pads in order to detect whether the glasses have been taken off.

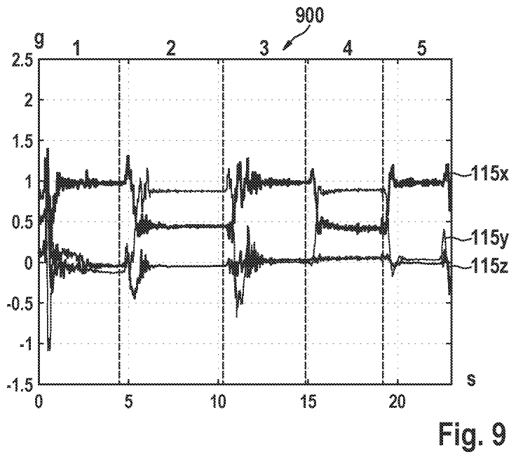

FIG. 9 shows a diagram 900 of a sensor signal 115 according to one exemplary embodiment. The sensor signal 115 shown here is merely an example of an acceleration g, plotted against time s, of a signal of an acceleration sensor of a pair of data glasses, as described in the preceding FIGS. 1, 3, 7 and 8, while the glasses are in different operating states. In this case, the sensor signal 115 is shown three times by way of example in order to present the signal not only as a sensor signal 115x along an x axis of the diagram 900, but also as a sensor signal 115y along a y axis and also as a sensor signal 115z along a z axis of the diagram 900.

In total, five different regions which are labeled with numbers 1 to 5 are highlighted in the representation shown here. In the first region 1, the user sets the glasses on his nose. In the second region 2, the user takes the glasses off his nose and pushes the glasses up on his head. In the third region 3, the user grasps the glasses and puts the glasses back on his nose. In the fourth region 4, the user is looking upwards while continuing to wear the glasses on his nose. In the fifth region 5, the user lowers his head and looks forward again. The regions 2 and 4 are here similar, since the glasses have the same orientation in both regions. However, the signals at the beginning of the second region 2 have higher-frequency components compared with the beginning of the fourth region 4, since the glasses in the second region 2 have been removed from the nose and pushed up on the head. Due to the characteristic signal course in the second region 2, it can be detected that the user has pushed the glasses up onto his head and is not simply looking upwards.

If an exemplary embodiment has an “and/or” link between a first feature and a second feature, this is to be understood to mean that the exemplary embodiment according to one example has both the first feature and the second feature and, according to a further exemplary example, either only the first feature or only the second feature.

What is claimed is:

1. A method for controlling data glasses, comprising the following steps:
reading a sensor signal of a sensor unit arranged on the data glasses, wherein the sensor signal represents a change of position of the data glasses in relation to a defined reference point and/or a movement of the data glasses; and
applying a function rule for controlling a function of the data glasses by using the sensor signal.

2. The method according to claim 1, wherein in the applying step, the function rule is applied to control a measurement function for measuring an object and/or to control a spirit-level function for aligning objects and/or to control an operating state function for controlling an operating state of the data glasses.

3. The method according to claim 2, wherein in the applying step, by using the sensor signal, a directional angle of the data glasses in relation to the object to be measured is determined, wherein by using the directional angle, the object is measured.

4. The method according to claim 3, further comprising:
re-reading the sensor signal, wherein in the applying step, by using the re-read sensor signal, a further directional angle of the data glasses in relation to the object to be measured and/or a distance which the data glasses have covered, is determined, wherein by using the directional angle and the further directional angle and/or the distance the object is measured.

5. The method according to claim 2, wherein in the applying step, by using the sensor signal, a display configured to display a spirit-level symbol is controlled, wherein the spirit-level symbol is displayed horizontally in relation to a width of the data glasses and/or horizontally in relation to a gravitational field of the earth.

6. The method according to claim 5, wherein in the applying step, a color marking of the spirit-level symbol is changed when, in the reading step, the sensor signal is read which represents a movement of the data glasses in a non-horizontal orientation of the data glasses in relation to the gravitational field.

7. The method according to claim 2, wherein, in the applying step, as an operating state function an active operating state is controlled when, in the reading step, the sensor signal represents a change of position of the data glasses into an active position at the defined reference point, and wherein a passive operating state is controlled when, in the reading step, the sensor signal represents a change of position of the data glasses into a passive position from the defined reference point to a different point arranged at a distance from the defined reference point.

8. The method according to claim 7, further comprising:
calibrating the data glasses when a passive operating state is being controlled in the applying step.

9. A device configured to control data glasses, the device configured to:
read a sensor signal of a sensor unit arranged on the data glasses, wherein the sensor signal represents a change of position of the data glasses in relation to a defined reference point and/or a movement of the data glasses; and
apply a function rule for controlling a function of the data glasses by using the sensor signal.

10. Data glasses, comprising:
at least one sensor unit configured to detect a change of position of the data glasses in relation to a defined reference point and/or a movement of the data glasses; and
a device configured to control the data glasses, the device configured to:
read a sensor signal of a sensor unit arranged on the data glasses, wherein the sensor signal represents the change of position of the data glasses in relation to the defined reference point and/or the movement of the data glasses, and
apply a function rule for controlling a function of the data glasses by using the sensor signal.

11. A non-transitory machine-readable storage medium on which is stored a computer program for controlling data glasses, the computer program, when executed by a computer, causing the computer to perform the following steps:
reading a sensor signal of a sensor unit arranged on the data glasses, wherein the sensor signal represents a change of position of the data glasses in relation to a defined reference point and/or a movement of the data glasses; and
applying a function rule for controlling a function of the data glasses by using the sensor signal.
